(19) United States
(12) Patent Application Publication
(10) Pub. No.: US 2016/0332916 A1
(43) Pub. Date: Nov. 17, 2016

(54) BENEFICIATING PROCESS

(71) Applicant: IMERYS CERAMICS FRANCE, Paris (FR)

(72) Inventor: Alexis ANCIA, St. Léonard de Noblet (FR)

(21) Appl. No.: 15/111,055

(22) PCT Filed: Dec. 1, 2014
(86) PCT No.: PCT/EP2014/076091

§ 371 Date: Jul. 12, 2016

(30) Foreign Application Priority Data
Jan. 14, 2014 (EP) 14368012.2

(51) Int. Cl. C04B 33/10; B03C 1/025; B03C 1/30; B03C 1/01

(52) U.S. Cl. CPC C04B 33/10; B03C 1/01; B03C 1/025; B03C 1/30

(57) ABSTRACT

A process for beneficiating a feldspar and/or feldspathoid containing feed material which comprises magnetic impurities, non-magnetic impurities and non-magnetic minerals to be beneficiated, the process comprising the steps of providing said feed material, forming an aqueous composition comprising said feed material and a magnetic enhancer reagent and subjecting said aqueous composition to wet magnetic separation.

### TECHNICAL FIELD

The present invention is directed to a process for beneficiating a feldspar and/or feldspathoid containing feed material which comprises magnetic impurities, non-magnetic impurities and non-magnetic minerals to be beneficiated.

### BACKGROUND

Processes currently used in the art to concentrate and separate mineral impurities from ore constituents present in naturally-occurring deposits, such as feldspar, typically involve one or more flotation steps sometimes in combination with a magnetic separation step. A conventional flotation process comprises the steps of crushing and grinding the ore material to reach a suitable degree of liberation, conditioning the ground material under basic or acid conditions with the addition of a collector and a promoter specific to the type of impurity to be removed, and floating the material to form an impurity-containing froth which is normally discarded and a cleaner feldspar product that remains in the flotation cell as a concentrate, commonly referred to as “tailings”. This process may require a further refining step to remove residual iron being minerals such as micas using a dry magnetic separation step after evaporating the water during a drying step.

Workers in this field have previously proposed a wet magnetic separation process for carbonate and kaolin containing minerals, such as described in WO-A-2008/085626, U.S. Pat. No. 8,033,398 B2 and U.S. Pat. No. 6,006,920. These process describe the addition of a magnetic enhancer reagent, typically based on magnetite particles and an associated surface active agent, to enhance the separation of low value impurities, e.g., magnetic impurities and other non-magnetic low value impurities, from the very fine carbonate and/or kaolin feed materials. WO-A-2008/085626 and U.S. Pat. No. 2,033,398 B2 suggest that the beneficiation of very fine carbonate and kaolin feed materials may be improved as the particle size of the magnetic particles of the magnetic enhancer is decreased, i.e., such that the particle size of the magnetic particles of the magnetic enhancer reagent is of a similar size to the particle size of the very fine carbonate and/or kaolin feed materials.

### SUMMARY OF THE INVENTION

The present invention is directed to a process for beneficiating a feldspar and/or feldspathoid containing feed material which comprises magnetic impurities, non-magnetic impurities and non-magnetic minerals to be beneficiated; said process comprising:
(a) providing, obtaining or preparing a feldspar and/or feldspathoid containing feed material which comprises magnetic impurities, non-magnetic impurities and non-magnetic minerals to be beneficiated;
(b) forming an aqueous composition comprising the feldspar and/or feldspathoid containing feed material and a magnetic enhancer reagent, wherein the magnetic enhancer reagent comprises one or more magnetic oxide particulate and one or more surface active agent;
(c) subjecting said aqueous composition to wet magnetic separation to produce a non-magnetic separation product having a reduced level of magnetic and non-magnetic impurities, and a magnetic separation product comprising the magnetic and non-magnetic impurities removed from the aqueous composition.

### BRIEF DESCRIPTION OF THE DRAWINGS

FIG. 1 is a schematic depiction of the magnetic zone of a wet magnetic separation apparatus.

FIG. 2 is an exemplary flow-sheet for beneficiating a feldspar ore which comprises magnetic impurities in accordance with the present invention.

FIG. 3 illustrates the particle size distribution (p.s.d.) of crushed feldspar containing feed material used in the Examples.

FIG. 4 summarizes the brightness measurements performed on each sample prepared in the Examples.

### DETAILED DESCRIPTION OF THE INVENTION

In accordance with the process of the present invention a feldspar and/or feldspathoid containing feed material which comprises magnetic impurities, non-magnetic impurities and non-magnetic minerals to be beneficiated is provided, obtained or prepared.

By “feldspar” is meant herein minerals such as plagiocalses (e.g., albite, oligoclase, andesine, labradorite, bytownite and anorthite), orthoclases and other potassium containing feldspars such as sanidine, microline and anorthoclase, petalites, barium containing feldspars such a hyalophane and celsian, and other similar materials occurring in granites, diorites, granodiorites, leptynites, albitites, feldspatic sand and other similar materials.

By “feldspathoid” is meant herein minerals such as nosean, analcime, cancrinite, leucite, nepheline (e.g., nepheline syenite), sodalite (e.g., hauyne) and lazurite plagiocalses, orthoclases, petalites, hyalophanes, and other similar materials occurring in granites, diorites, granodiorites, leptynites, albitites, feldspatic sand and other similar materials. Feldspathoids are a group of minerals which resemble feldspars but have a different structure and typically a much lower silica content.

In certain embodiments, the feed material is a feldspar containing feed material, i.e., it comprises at least one feldspar mineral. In certain embodiments, the feed material is a feldspathoid containing feed material, i.e., it comprises at least one feldspathoid mineral. In certain embodiments, the feed material is a feldspar and feldspathoid containing feed material, i.e., it comprises at least one feldspar mineral and at least one feldspathoid mineral. In an embodiment, the feldspar containing feed material is an albitic ore, i.e., a feed material comprising albite, for example, a Turkish albitic ore, e.g., an albite deposit of the Milas region (Mu\check{g}la, Trukey). In certain embodiments, the feldspar containing feed material is an albite containing deposit comprising albite, one or more Fe-bearing minerals and one or more Ti-bearing minerals, for example, an albite containing deposit comprising albite, biotite, rutile and/or sphene, and one or more of quartz, muscovite, and apatite, for example, an albite containing deposit comprising albite, biotite, rutile, quartz, muscovite, sphene and apatite.

The feed material comprises magnetic impurities, non-magnetic impurities and non-magnetic minerals to be beneficiated. The term “impurities” means particulate material or materials, typically minerals, which are to be at least partially removed from the feed material in order to beneficiate the feed material, i.e., improve one or more properties of the feed material, such as brightness. The impurities are less desirable (i.e., of less value) than the feldspar and/or feldspathoid minerals. The term “magnetic impurities” used herein means particulate material or materials, typically minerals, which bear a magnetic component, e.g., iron. In certain embodiments, the magnetic impurities comprise or are magnetic particles, e.g., Fe-bearing particles. The term “non-magnetic impurities” means particulate material or materials, typically minerals, which do not contain a magnetic component which is detectable by a magnetic detection method, but nevertheless are desirable to remove from the feed material. In certain embodiments, the non-magnetic impurities comprise Ti-bearing, P-bearing and/or Cr-bearing particles, typically in oxide form. In certain embodiments, the non-magnetic impurities comprise, consist essentially of, or consist of, at least Ti-bearing particles (i.e., titaniferous impurities).

In certain embodiments, the process is a process for beneficiating a feldspar and/or feldspathoid containing feed material which comprises, magnetic particles, Ti-bearing particles and non-magnetic minerals to be beneficiated.

In certain embodiments, a crushed and/or milled feldspar and/or feldspathoid containing feed material is subjected to sizing, for example, screening to form at least a fine fraction and a coarse fraction, said coarse fraction comprising particles greater than about 1 mm in size. In an embodiment, the crushed and/or milled feldspar and/or feldspathoid containing feed material is screened to obtain the fine fraction and course fraction using a screen, for example a wet screen, having holes of an appropriate size. The mesh screen may possess a hole size of 1 mm (i.e., 1000 μm). This corresponds to US mesh size 18. Suitable screens are well known to persons skilled in the art. Thus, in embodiments the fine fraction is substantially free of particles which do not pass through a screen which possesses a hole size of 1 mm. As used herein the term “substantially free” refers to the total absence of or near total absence of a specific component, compound or composition. For example, when the fine fraction is said to be substantially free of particles which do not pass through a screen having 1 mm holes, there are either no such particles in the fine fraction or only trace amounts of such particles in the fine fraction. A person skilled in the art will understand that a trace amount is an amount which may be detectable but not quantifiable and moreover, if present, would not adversely affect the properties of the fine fraction or the processes of the invention applied thereto.

In other embodiments, the crushed and/or milled feldspar and/or feldspathoid containing feed material is subjected to sizing to form at least a fine fraction and a coarse fraction, said coarse fraction comprising particles greater than about 950 μm, or greater than about 850 μm in size. In an embodiment, the crushed feldspar containing feed material is screened, for example, by wet screening, to obtain the fine fraction and course fraction using a screen which possesses a hole size of 950 μm, or 850 μm.

In further embodiments, the crushed and/or milled feldspar and/or feldspathoid containing feed material is subjected to sizing to form at least a fine fraction and a coarse fraction, said coarse fraction comprising particles greater than about 800 μm in size. In certain embodiments, the coarse fraction comprises particles greater than about 700 μm in size, or greater than about 630 μm in size. In an embodiment, the crushed and/or milled feldspar and/or feldspathoid containing feed material is screened, for example, by wet screening, to obtain the fine fraction and course fraction using a screen which possesses a hole size of 800 μm, 700 μm or 630 μm.

In further embodiments, the crushed and/or milled feldspar and/or feldspathoid containing feed material is subjected to sizing to form at least a fine fraction and a coarse fraction, said coarse fraction comprising particles greater than about 550 μm in size, or greater than about 475 μm in size, or greater than about 400 μm in size. In an embodiment, the crushed and/or milled feldspar containing feed material is screened, for example, by wet screening, to obtain the fine fraction and course fraction using a screen which possesses a hole size of 550 μm, 475 μm, or 400 μm.

In certain embodiments, the fine fraction comprises particles greater than about 200 μm in size, for example, greater than about 250 μm in size, or greater than about 315 μm in size, or greater than about 400 μm in size, or greater than about 475 μm in size, or greater than about 550 μm in size, or greater than about 630 μm in size, or greater than about 700 μm in size, or greater than about 800 μm in size. In certain embodiments, at least 10% by weight of the fine fraction comprises particles greater than about 200 μm in size (or greater than about 250 μm, or greater than about 315 μm, or greater than about 400 μm, or greater than about 475 μm, or greater than about 550 μm, or greater than about 630 μm, or greater than about 800 μm in size), for example, at least about 20% by weight, or at least about 30% by weight, or at least about 50% by weight, or at least about 60% by weight, at least about 70% by weight of the fine fraction comprises particles greater than 200 μm in size (or greater than about 250 μm, or greater than about 315 μm, or greater than about 400 μm, or greater than about 475 μm, or greater than about 550 μm, or greater than about 630 μm, or greater than about 700 μm, or greater than about 800 μm in size, or greater than about 850 μm).

In another embodiment, the fine fraction comprises particles of up to about 315 μm in size, i.e., particles of a size which pass a screen which possesses a hole size of 315 μm. The fine fraction may comprise particles of up to about 400 μm in size, for example, up to about 475 μm in size, or up to about 550 μm in size, or up to about 630 μm in size, or up to about 700 μm in size, or up to about 800 μm in size, or up to about 850 μm in size, or up to about 950 μm in size.

A conversion chart between US mesh size and microns is provided below.

| US Mesh | μm |
|---|---|
| 4 | 4760 |
| 5 | 4000 |
| 6 | 3360 |
| 7 | 2830 |
| 8 | 2380 |
| 10 | 2000 |
| 12 | 1680 |
| 14 | 1410 |
| 16 | 1190 |
| 18 | 1000 |
| 20 | 840 |
| 25 | 710 |
| 30 | 590 |
| 35 | 500 |
| 40 | 420 |
| 45 | 350 |
| 50 | 297 |
| 60 | 250 |
| 70 | 210 |
| 80 | 177 |
| 100 | 149 |
| 120 | 125 |
| 140 | 105 |
| 170 | 88 |
| 200 | 74 |
| 230 | 62 |
| 270 | 53 |
| 325 | 44 |
| 400 | 37 |
| 500 | 31 |

The feldspar and/or feldspathoid containing feed material may be obtained from a feldspar and/or feldspathoid ore, suitably crushed and optionally ground/milled to obtain a feldspar and/or feldspathoid containing feed material having a particle size up to about 20 mm, for example, up to about 15 mm, or up to about 10 mm, or up to about 8 mm, or up to about 6 mm, or up to about 4, or up to about 2 mm. Methods of crushing and grinding/milling are well known to persons skilled in the art. Advantageously, the average particle size of the fine fraction is not further reduced by physical abrasion (e.g., by grinding or milling and the like) prior to being subjected to wet magnetic separation.

At any stage of the process very fine particles may be removed from the fine fraction, the aqueous suspension thereof, or the magnetic separation product(s) (which, as described below, may be a first pass, second pass or third pass product). Thus, in an embodiment, the fine fraction, the aqueous suspension thereof or the first magnetic separation product is treated to remove very fine particles up to about 20 μm in size, for example, up to about 30 μm in size, or up to about 40 μm in size, or up to about 50 μm in size, or up to about 60 μm, or up to about 70 μm in size. Fines removal may be effected by hydrocycloning, wet screening or any other suitable desliming system. Advantageously, very fine particles are removed by hydrocycloning. In other embodiments, very fine particles are removed from the fine fraction, the aqueous suspension thereof, or the first magnetic separation product by wet screening with a 20 μm screen, or a 25 μm screen, or a 30 μm screen, or a 35 μm screen, or a 40 μm screen, or a 45 μm screen, or a 50 μm screen, or a 55 μm screen, or a 60 μm screen, or a 65 μm screen, or a 70 μm screen. Advantageously, the aqueous suspension is deslimed prior to wet magnetic separation by wet screening with a 20 μm or, more preferably, a 50 μm or 55 μm screen. Advantageously, the aqueous suspension is subjected to hydrocycloning prior to wet magnetic separation to remove very fine particles up to about 20 μm in size or, more preferably, up to about 50 μm or 55 μm in size.

An aqueous composition, for example, an aqueous suspension, comprising the feldspar and/or feldspathoid containing feed material and a magnetic enhancer reagent is formed. The magnetic enhancer reagent comprises one or more magnetic oxide particulate and one or more surface active agent.

In certain embodiments, the aqueous suspension is formed having a solids content ranging from about 5 wt. % to about 70 wt. %, based on the total weight of the aqueous suspension. In certain embodiments, the aqueous suspension of said fine fraction and magnetic enhancer reagent is formed having a solids content ranging from about 10 wt. % to about 70 wt. %, for example, from about 10 to about 60 wt. %, or from about 10 to about 50 wt. %, or from about 20 wt. % to about 50 wt. %, or from about 30 wt. % to about 50 wt. %, or from about 20 wt. % to about 40 wt. %, or from about 30 to about 40 wt. %, or from about 35 wt. % to about 40 wt. %, or from about 25 wt. % to about 45 wt. %, or from about 30 wt. % to about 45 wt. %, or from about 35 wt. % to about 45 wt. %. In another embodiment, the solids content of the aqueous suspension is equal to or less than about 60 wt. %, or equal to or less than about 55 wt. %, or equal to or less than about 50 wt. %, or equal to or less than about 45 wt. %, or equal to or less than about 40 wt. %. In another embodiment, the solids content of the aqueous suspension is at least about 10 wt. %, or at least about 15 wt. %, or at least about 20 wt. %, or at least about 25 wt. %, or at least about 30 wt. %, or at least about 35 wt. %.

A magnet enhancer reagent (a) is a reagent that enhances the removal of magnetic and non-magnetic impurities from the feldspar and/or feldspathoid containing feed material (i.e., relative to the impurities removed under magnetic separation without the magnetic enhancer reagent added). In certain embodiments, the magnet enhancer reagent enhances the removal of iron- and/or titanium-containing impurities from the feldspar and/or feldspathoid containing feed material. The magnet enhancer reagent is a composition comprising one or more magnetic oxide particulate and one or more surface active agents that can aid in the attachment of the magnetic oxide to the impurity. Magnetic oxides and surface active agents can be added together or separately in forming the aqueous suspension. Magnetic oxides in the reagent can be represented generally by the formula MO, wherein M is a divalent metal such as Fe, Ni, Co, Mn, and Mg. Magnetic oxides in the reagent can include, for example, iron oxides (e.g. FeO, Fe₂O₃ (magnetite), Fe₃O₄), cobalt oxides, nickel oxides, and any metal combination such as ferroso-ferric oxides, cobalt ferric oxides (CoFe₂O₄), NiFe₂O₄. Additional suitable magnetic oxides are described in U.S. Pat. No. 4,906,382, U.S. Pat. No. 4,834,898, U.S. Pat. No. 4,125,460 and, U.S. Pat. No. 4,078,004, the entire contents of which are hereby incorporated by reference. In certain embodiments, the magnetic oxide comprises or is magnetite.

In certain embodiments, the magnetic oxide particulate has an average particle size of no greater than about 200 μm, for example, no greater than about 150 μm, or no greater than about 100 μm. In certain embodiments, the magnetic oxide particulate has an average particle size of from about 0.01 μm to about 200 μm, for example, from about 0.1 μm to about 200 μm, or from about 1.0 μm to about 200 μm, or from about 1.0 μm to about 150 μm, or from about 1.0 μm to about 100 μm, or from about 0.1 μm to about 75 μm, or from about 1.0 μm to about 50 μm. Particle size may be determined by measuring their surface areas using BET N₂ adsorption techniques, for example, as described in WO-A-2008/085626, the entire contents of which are hereby incorporated by reference. In this respect, it has unexpectedly been found that a magnetic enhance reagent comprising magnetic particles which are relatively small in comparison to the particles of the fine fraction of the feldspar and/or feldspathoid feed material to be treated in accordance with the process of the present invention. This is advantageous as it means the feldspar and/or feldspathoid feed material being beneficiated does not necessarily have to be sized down (e.g., by grinding or screening) to a particle size which is comparable to the particle size of the magnetic oxide particulate, thereby saving energy and reducing cost.

In certain embodiments, the conductivity of the magnetic enhancer reagent may be up to about 50 mS/cm, for example, up to about 25 mS/cm, or up to about 10 mS/cm, or up to about 5 mS/cm, or up to about 2 mS/cm, or from about 0.1 to about 2 mS/cm.

A “surface active reagent” as used herein means a surfactant or blend of surfactants that is associated with the magnetic oxide, e.g., attached, e.g., chemically bonded or physisorbed to the surface of the particles of magnetic oxide. In certain embodiments, the surface active agent comprises a chemical functionality which preferentially adsorbs to the surface of the magnetic and/or non-magnetic impurity particles, e.g., iron- and/or titanium-containing impurities. Suitable surfactants typically have molecules exhibiting a long hydrophobic tail and optionally a cloud point above 65° C. Suitable surfactants typically have relatively low HLB values, such as 10 or less, 9 or less, 8 or less, 7 or less, 6 or less, or 5 or less, where HLB equals the ratio of weight percentages of hydrophilic to hydrophobic groups in the molecule. Examples of suitable surface active agents are listed in U.S. Pat. No. 5,527,426 (Marwah et al.). Additional magnet enhancement reagents include products referred to as TX-9263 or TX-9520 or 95DM144 or 9868 (Nalco Chemical Co. Naperville, Ill.), a product referred to as Aero NSK-150-high conductivity magnetite suspension and impurity-selective surface active reagents—available from Cytec Industries Inc. Woodland Park, N.J.). Additional magnet enhancement reagents include those described in U.S. Pat. No. 8,033,398 B2, the entire contents of which are hereby incorporated by reference, more particularly, as described in claim 1 of U.S. Pat. No. 8,033,398 B2, a magnetic oxide particulate (e.g., magnetite) associated with a surface active reagent of the formula R—(CONH—O—X)ₙ, wherein n is from 1 to 3; X is individually selected from the group consisting of H. M and MR′₄; M is a metal ion (e.g., lithium, sodium, potassium, magnesium, or calcium, preferably sodium or potassium); R comprises from about 1 to about 50 carbon atoms; and each R′ is individually selected from the group consisting of H. C₁-C₁₀ alkyl, C₆-C₁₀ aryl and C₇-C₁₀ aralkyl. Examples of suitable R groups include butyl, pentyl, hexyl, octyl, dodecyl, lauryl, 2-ehtylhexyl, oleyl, eicosyl, phenyl, tolyl, napthyl and hexylphenyl. Additional magnetic enhancement reagents include those described in WO-A2008/085626. For example, the surface active agent may be selected from the group consisting of tallow fatty amine surfactants, amine cationic surfactants, tallow alkyl amine surfactants, quaternary ammonium surfactants, ammonium surfactants, dicocoalkyl, dimethyl quaternary ammonium surfactants, imidazoline collectors, benzyltrialkylammonium surfactants, trialkylalkenylammonium surfactants, tetralakyl ammonium surfactants and subsistituted derivatives thereof, oxazoline surfactants, morpholine surfactants and mixtures thereof. In certain embodiments, the surface reactive agent is selected from the group consisting of methyl-bis(2-hydroxypropyl)-cocoalkyl ammonium methyl sulphate, dimethyl didecyl ammonium chloride, dimethyl-di/2-ethylhexyl)-ammonium chloride, dimethyl-(2-ethyl-hexyl)-cocoalkyl ammonium chloride, dicocoalkyl dimethvl ammonium chloride, n-tallow alkyl-1,3-diamino propane diacetate, dimethyl dicocoalkyl ammonium chloride, 2-methyl-2-imidazoline, ethylene bis-imidazoline, tall oil oxazoline, tall oil amidomorpholine, and mixtures thereof. Exemplary surface active agents include CYTEC S6493, CYTEC SS6494, CYTEC S8881 and CYTEC S9849 MINING REAGENTS (RTM) available from Cytec Industries Inc., NJ. Other surface active agents include fatty amine salts such as AERO 31000 (RTM) and AERO 3030C (RTM) which are both fatty ammonium acetate salt. AEROMINE 8625A (RTM) which is a primary tallow amine acetate salt, and AEROMINE 8651 (RTM) which is an amine condensate, all available from Cytec Industries Inc., NJ.

In certain embodiments, the surface active agent (and thus the magnetic enhancer reagent) does not comprise a surface active amine functionally.

In certain embodiments, the weight ratio of magnetic oxide particulate to surface active agent is from about 10:1 to about 1:10, for example, from about 5:1 to about 1:5, or from about 3:1 to about 1:3, or from about 2:1 to about 1:2, or about 1:1.

The term “secondary selective organic reagent” as used herein means a surfactant or a blend of surfactants that, when associated to a magnet enhancer reagent, may further enhance the removal of magnetic and non-magnetic impurities from the feldspar and/or feldspathoid containing feed material (i.e., relative to the impurities removed under magnetic separation with only a magnetic enhancer reagent added). In certain embodiments, the secondary selective organic reagent further enhances the removal of iron- and/or titanium-containing impurities from the feldspar and/or feldspathoid containing feed material. Without wishing to be bound by theory, it is believed that the secondary selective organic reagent serves to selectively agglomerate the desired mineral impurities to be removed by the magnetic separation. Suitable secondary selective organic reagents include, but are not limited to, chelating surfactants such as hydrocarbyl hydroxamate-based reagents, e.g., alkyl hydroxamate-based reagents, The benefits of chelating surfactants include: enhanced selectivity for titanium oxide and transition metal ions; reduction in the energy during activation of impurities before separation; higher activity; higher stability; and an easier handling. The hydroxamate may be associated with a counter metal ion, such as an alkali metal such as sodium or potassium. The hydrocarbyl group may be an R group comprising from 1 to about 20 carbon atoms, for example, from about 4 to about 16 carbon atoms, or from about 6 to about 12 carbon atoms. The R group may be an alkyl or aryl group. In certain embodiments, the R group is an alkyl group, for example, having from about 4 to 16 carbon atoms. Exemplary secondary selective organic reagents include Cytec products referred to as Aero NSK-200 and Aero NSK-300, available from Cytec Industries Inc. Woodland Park, N.J. Other secondary selective organic reagents include surfactants which are useful as flotation collectors, e.g., fatty acids, fatty amines, xanthates, dithiophosphates and petroleum sulfonates. Other suitable secondary selective organic agents include collectors (e.g., cationic (e.g., based on heptavalent nitrogen), anionic (e.g., of the oxhydryl or sulphydryl type) and non-ionic (e.g., non-polar hydrocarbons which do not dissociate in water)) which may be used to increase the hydrophobicity of mineral particles.

In certain embodiments, the magnet enhancer reagent (optionally having between 5 and 10% activity) is present in the aqueous suspension at about 0.5 kg/ton to about 40 kg/ton of the fine fraction of the feldspar and/or feldspar containing feed material, for example, from about 5 to 30 kg/ton, or about 10 to 20 kg/ton of the fine fraction of the feldspar and/or feldspar containing feed material. “Between 5 and 10% activity” means between 5 and 10% solids concentration of the magnetic oxide, e.g., iron oxide, based on the total weight of the suspension.

In certain embodiments, the secondary selective organic reagent is present at 0 kg/ton to about 2 kg/ton of the fine fraction of the feldspar and/or feldspar containing feed material, for example, from about 0.3 to about 1.7 kg/ton, or from about 0.6 to about 1.35 kg/ton of the fine fraction of the feldspar and/or feldspar containing feed material.

In certain embodiments, the magnetic enhancer reagent is Aero NSK-150 and, if present, the secondary selective organic reagent is Aero NSK-200 and/or Aero NSK-300.

The aqueous suspension may be made by combining a pre-determined weight of the fine fraction with a pre-determined volume of water and a pre-determined amount of magnetic enhancer reagent and optional secondary selective organic reagent in a feed preparation vessel. The various components may be added simultaneously, independently, or in combination, or in any order. The resulting slurry may then be agitated by means of a mechanical stirrer until dispersed and homogenous. The dispersed slurry may then be pumped at an even flow rate through the energized wet magnetic separation apparatus.

In certain embodiments, the aqueous suspension comprising the magnet enhancer reagent and optional secondary selective organic reagent is conditioned. “Conditioning” is a term known in the art for imparting high shear to particles in an aqueous environment. Any type of rotor device that can impart high shear to the particles can be used. By imparting high shear is meant imparting typically the shear achieved by a rotor blade tip speed of at least 15 m/s, and usually of a range of about 15 to about 60 m/s. Any suitable rotor device that can achieve a rotor blade tip speed of about 15 to 60 m/s can be utilized for conditioning in this method. The aqueous suspension may be conditioned for a time sufficient to enhance the subsequent magnetic separation step, so long as no adverse effects on the feldspar quality are incurred. Conditioning times can vary according to the device used to impart the shear. Conditioning can be performed for any suitable time period greater than 0 seconds.

For example, the aqueous suspension may be conditioned for about 1 minute to about 20 minutes, for example, from about 2 minutes to about 15 minutes, or from about 3 minutes to about 12 minutes, or from about 4 minutes to 10 minutes, or from about 5 minutes to 8 minutes.

Furthermore, at any stage in the process, typically prior to wet magnetic separation, the pH of the aqueous suspension may be adjusted to about 2.0 to about 11.0, for example, from about 5.0 to about 11.0, or from about 7.0 to about 11.0. The pH may be, for instance, from about 8.0 to about 10.0, or from about 8.5 to 9.0, or from about 8.0 to 9.5. If necessary, to raise pH, one may use any alkaline compound such as sodium hydroxide, soda ash, sodium silicate, lime, or a mixture thereof. To lower the pH, one may use an acidic compound such as sulphuric acid, hydrochloric acid and hydrofluoric acid, preferably sulphuric acid and/or hydrochloric acid. In certain embodiments, the pH modifier is added prior to adding the magnet enhancer reagent the aqueous suspension. Additionally, prior wet magnetic separation, the solids content of the optionally conditioned aqueous suspension may be adjusted if necessary to from about 10% to about 50%, for example, from about 20% to about 40%, or from about 25% to about 35%.

The optionally conditioned feldspar and/or feldspathoid containing aqueous suspension is then subjected to (high gradient) wet magnetic separation to produce a non-magnetic separation product having a reduced level of magnetic and non-magnetic impurities (e.g., magnetic and non-magnetic particles, such as Fe- and Ti-bearing particles) and a magnetic separation product comprising the magnetic and non-magnetic impurities removed from the aqueous composition. The non-magnetic separation product (in certain embodiment, the first non-magnetic separation product) will be a feldspar- and/or feldspathoid-rich separation product, preferably having a reduced level of iron- and titanium-containing particles. The magnetic separation product (in certain embodiments, the second magnetic separation product) comprises the magnetic particles removed from the conditioned aqueous suspension. High gradient magnetic separation is a process generally known in the art, and is described, e.g., in U.S. Pat. No. 4,125,460 (Nott et al.), U.S. Pat. No. 4,078,004 (Nott et al.) and U.S. Pat. No. 3,627,678 (Marston). High gradient magnetic separation step may be conducted using any suitable wet magnetic separation apparatus. In general, a suitable apparatus comprises a stainless steel matrix having an open structure (e.g. stainless steel wool, stainless steel balls, nails, tacks, meshes, etc.), subjected to a magnetic field, through which the optionally conditioned aqueous suspension is passed. The retention time in the magnet matrix depending on the slurry velocity through the matrix and the magnet cycle can be varied as desired, according to standard methods. The high gradient magnetic separation is preferably performed at a time from about immediately after conditioning to about 7 days after conditioning, for example, within about 4 days after conditioning, or may be performed immediately after conditioning.

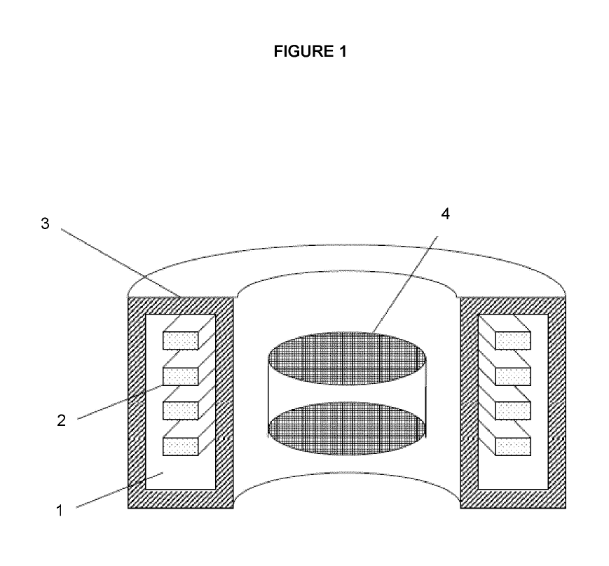

An exemplary apparatus is a High Intensity Filter 800-100 (coil cooled by oil bath) manufactured by Eriez (Eriez Magnetics Europe Limited, Caerphilly, UK) fitted with a 1016 mm diameter canister equipped with different types of matrices suited to the particles size distribution of the minerals. The matrix is made of stainless steel 430 grid type with diamond apertures: coarse grid CX—30×12 mm; medium grid MX—19.05×7.25 mm; BEX grid—9.95×6.60 mm; fine grid FX—5.84×3.38 mm. The magnetic particles are trapped within the mesh of the matrix. A section of a magnetized zone is depicted schematically in FIG. 1. An annular steel circuit (3) surrounds a core containing a matrix (4). The matrix is a mesh made from stainless steel. For clarity, only ‘top’ and ‘bottom’ meshed sections of the matrix is shown in FIG. 1. Resistive coils (2) are located inside the steel circuit (3) and formed about the matrix (4). A bath of cooling oil (1) surrounds the resistive coils (2).

The magnetic field applied during the wet magnetic separation step may be up to about 2.0 Tesla, for example, from about 0.5 to about 2.0 Tesla. In embodiment, the magnetic field applied during the separation step is from about 0.5 to about 1.5 Tesla, for example, from about 0.5 to about 1.0 Tesla. In other embodiment, the magnetic field applied during the separation step is about 0.6 Tesla, or about 0.8 Tesla, or about 1.0 Tesla, or about 1.2 Tesla, or about 1.4 Tesla, or about 1.6 Tesla, or about 1.8 Tesla. Advantageously, the magnetic field applied is comprised between 1.0 and 1.2 Tesla.

The velocity of the optionally conditioned aqueous suspension through the wet magnetic separation apparatus may be from about 0.5 cm/s to about 10.0 cm/s, for example, from about 2.0 cm/s to about 8.0 cm/s, or from about 3.0 cm/s to about 6.0 cm/s, or from about 3.0 cm/s to about 5.0 cm/s, or from about 4.0 cm/s to 6.0 cm/s.

The flow rate of the aqueous suspension through the wet magnetic separation apparatus may be from about 10 L/min to about 100 L/min, for example, from about 20 L/min to about 80 L/min, or from about 30 L/min to about 60 L/min. In an embodiment, the flow rate of the aqueous suspension through the wet magnetic separation apparatus is about 10 L/min, or about 20 L/min, or about 30 L/min, or about 40 L/min, or about 50 L/min, or about 60 L/min, or about 70 L/min, or about 80 L/min, or about 90 L/min, or about 100 L/min. In one embodiment, the aqueous suspension, having a solids content of from about 25 to 45 wt. %, is fed into the magnetized zone by means of a pump with a flow rate of about 50 L/min and the resulting first separation product is collected.

In other embodiments, the flow rate of the aqueous suspension through the wet magnetic separation apparatus may be from about 40 m³/hour to about 200 m³/hour, for example, from about 60 m³/hour to about 180 m³/hour, or from about 80 m³/hour to about 160 m³/hour, or from about 100 m³/hour to about 140 m³/hour. In one embodiment, the aqueous suspension, having a solids content of from about 25 to 45 wt. %, is fed into the magnetized zone by means of a pump with a flow rate of from about 40 m³/hour to about 200 m³/hour and the resulting first separation product is collected.

Following wet magnetic separation, the magnet is de-energized and the magnetic separation product trapped with the mesh of the matrix, containing the mineral impurities (e.g., iron- and titanium-bearing minerals), is then discharged, for example using a water and compressed air flush from both the top and/or bottom of the matrix. This step may be carried out between passes of the aqueous suspension/first magnetic separation product through the wet magnetic separation apparatus.

Additionally, the wet magnetic separation step may be repeated as many times as necessary. Thus, in this case, a first magnetic separation product collected after a first pass through the wet magnetic separation apparatus may be conditioned again with magnet enhancer reagent and optionally secondary selective organic reagent and then be fed again to the wet magnetic separation apparatus to separate further magnetic particles, thereby forming a second pass magnetic separation product. The second pass magnetic separation product collected after the second pass through the wet magnetic separation apparatus may be conditioned once again with magnet enhancer reagent and optionally secondary selective organic reagent and fed a third time through the wet magnetic separation apparatus, thereby forming a third pass magnetic separation product. In certain embodiments, further passes (i.e., more than three) through the wet magnetic separation apparatus are not contemplated. In certain embodiments, more than three passes (e.g., four, or five, or six, etc) through the wet magnetic separation are contemplated.

The magnetic separation product has a reduced level of magnetic and non-magnetic impurities relative to the fine fraction of the aqueous suspension and is feldspar and/or feldspathoid-rich. Thus, magnetic and non-magnetic impurity particles are preferentially removed from the fine fraction of the aqueous suspension during the wet magnetic separation step. The magnetic particles may are predominantly iron-bearing minerals. The content of iron bearing minerals in any given feldspar/feldspathoid containing feed material (e.g., feldspar ore) is normally expressed in terms of its Fe₂O₃ content, as determined by XRF. In an embodiment, the Fe₂O₃ content of the fine fraction prior to wet magnetic separation is at least about 0.15 wt. % based on the total weight of the fine fraction, for example, at least about 0.20 wt. %, or at least about 0.25 wt. %, or at least about 0.30 wt. %, or at least about 0.35 wt. %, or at least about 0.40 wt. %, or at least about 0.45 wt. %, or at least about 0.50 wt. %, or at least about 0.55 wt. %., or at least about 0.60 wt. %. Feldspar containing feed materials also bear Ti containing minerals, normally expressed in terms of its TiO₂ content, as determined by XRF. Thus, in an embodiment, the fine fraction prior to wet magnetic separation additionally comprises at least about 0.15 wt. % TiO₂, based on the total weight of the fine fraction, for example at least about 0.20 wt. %, or at least about 0.25 wt. %, or at least about 0.30 wt. %, or at least about 0.35 wt. %, or at least about 0.40 wt. %, or at least about 0.45 wt. %, or at least about 0.50 wt. %.

In an embodiment, at least about 50% of Fe₂O₃ is removed from the fine fraction during wet magnetic separation, for example, at least about 60%, or at least about 70%, or at least about 80%, or at least about 90%, or at least about 95% of Fe₂O₃ is removed. Additionally, at least about 30% of TiO₂ is removed from the fine fraction during wet magnetic separation, for example, at least about 40%, or at least about 50%, or at least about 60%, or at least about 70%, or at least about 80%, or at least about 90%, or at least about 95% of TiO₂ is removed.

After magnetic separation, any typical processing may be performed on the resultant magnetic separation product. For example, the (first, second, third, etc) magnetic separation product may be blended with the coarse fraction obtained in certain embodiments. Any suitable blend may be prepared depending on the chemical composition of the magnetic separation product and the coarse fraction, and the required quality of the blended product. For example, the blended product may comprise from about 10 to about 90 wt. % of the magnetic separation product and from about 90 to about 10 wt. % of the coarse fraction, for example, from about 20 to about 80 wt. %, or from about 30 to about 70 wt. %, or from about 40 to about 60 wt. %, or about 50 wt. % of the magnetic separation product, with the corresponding balanced coarse fraction. Generally, the blend will comprise a majority of the magnetic separation product, for example, a weight ratio of the first magnetic separation product to the coarse fraction of about 60:40, or about 70:30, or about 80:20, or about 90:10.

Alternatively, the magnetic separation product collected from the wet magnetic separation apparatus may be subjected to a flotation process to remove further mineral particles, for example, quartz minerals. Flotation processes are well known in the art. The first magnetic separation product, in the form of an aqueous suspension, may be conditioned by treating with a cationic collector (e.g., amine-group), and an optional foaming agent. The pH of the aqueous suspension may be reduced by addition of suitable pH modifying agent. Flotation is carried out by bubbling air or nitrogen through the suspension. Feldspar and/or feldspathoid particles are then recovered in the froth or foam thus generated, while the other constituents, e.g., quartz minerals, remain in the tailings. However, in certain embodiment, the process does not comprise a flotation process to remove non-magnetic impurities other than quartz. In other embodiments, quartz minerals, when present, may be separated from the feed material and/or the fine fraction formed therefrom, prior to wet magnetic separation. This separation may be effected by flotation, as described above.

Alternatively or additionally, the feldspar/feldspathoid-rich product can be dewatered (i.e. filtered) and then optionally dried, for example, in an oven at temperature higher than 100° C., for example, about 110° C.

Once dried, the feldspar/feldsapthoid-rich product may be ground according to the techniques well-known in the art in order to meet the particles size distribution specifications required by certain applications.

As described above, then, the feldspar and/or feldspathoid containing material for either method can comprise any feldspar, crude, processed or partially processed to beneficiated, for example, in which an increase in brightness is desired. For example, feldspar and/or feldspathoid containing feed material subjected to the present invention can have been initially crushed/ground, or floated, or can result from dry or wet conventional high intensity magnetic separation, or from any gravimetric treatment, or any electrostatic treatment, etc.

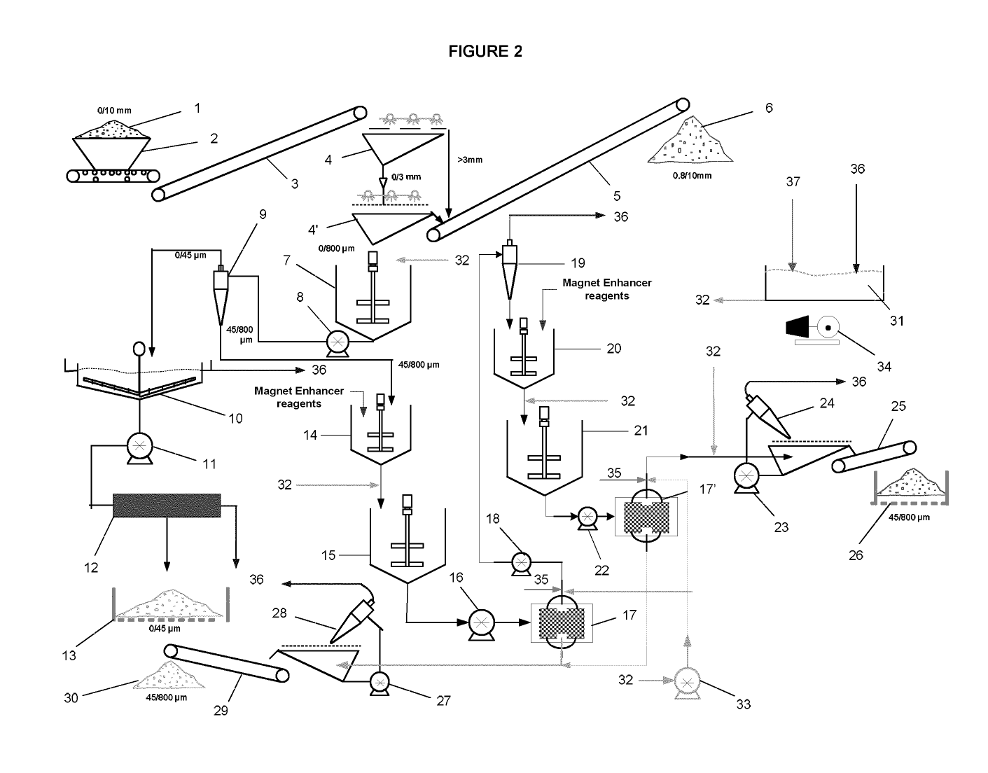

An exemplary industrial flow sheet for a beneficiation process according to the present invention is shown in FIG. 2. A crushed feldspar ore 1 is fed from hopper 2 via belt 3 to two single deck screens 4 and 4′. The decks comprise a mesh screen which have respectively aperture sizes 3 and 0.8 mm. A coarse fraction 6 (0.8/10 mm) is separated from a fine fraction (0/800 μm). The coarse fraction is collected via belt 5 for optional further processing. The fine fraction is combined with water 32 from pool 31 (which comprises fresh water 37 and recycle water 36) in agitated tank 7 and is subjected to fine removals via cyclone racks 9 which are operatively connected to centrifuge pump 8. A very fine 0/45 μm fraction is fed to thickener apparatus 10 (operatively connected to centrifuge pump 11). Recycle water 36 may be drawn from the thickener apparatus and fed to water pool 31. The thickened fines fraction is fed to filter press 12 and a 0/45 μm Shlamms product 13 is collected. Water 36 from filter press 12 may be recycled to pool 31. A 45/800 μm fraction is fed to agitated conditioning tank 14 where effective magnet enhancer reagent and optionally selective organic agent and optionally pH modifier are added to the slurry. Recycled water 32 from water pool 31 can be added to the conditioned slurry in agitated tank 15 in order to reduce the solids % of the pulp prior to magnetic separation step. The conditioned and diluted slurry is then fed to first Wet High Intensity Magnets (WHIMs) 17 and subjected to wet magnetic separation. Following wet magnetic separation, a first magnetic separation product exits the WHIMs and is subjected to water removal via hydrocyclone 19 which is operatively connected to centrifuge pump 18. The dewatered first magnetic separation product is fed to second agitated conditioning tank 20 where effective magnet enhancer reagent and optionally selective organic agent and optionally pH modifier are added again to the slurry. Recycled water 32 from water pool 31 can be added to the re-conditioned slurry in agitated tank 21 in order to reduce the solids % of the pulp prior to second magnetic separation step. The conditioned and diluted first magnetic separation product is fed to the second WHIMs 17′ and subjected again to wet magnetic separation. Following second wet magnetic separation, a first magnetic separation product exits the WHIMs and passed to dewatering rig 24 (which is operatively connected to centrifuge pump 23). The dewatered product 26 is collected via belt 25 for optional further processing. Second magnetic separation products coming from both first and second magnetic separation steps (comprising magnetic particles removed from slurry) are removed from the matrix of the WHIMs 17 and 17′ and fed to dewatering unit 28 (which is operatively connected to centrifuge pump 27). Second magnetic separation products may be flushed from within the matrix of the WHIMs 17 and 17′ by using water 32 (operatively connected to centrifuge pump 33) and compressed air 35 (operatively connected to compressor 34). The dewatered product 30 is collected via belt 29 for optional further processing.

In the illustrated embodiment both WHIMs 17 and 17′ are arranged in series. However, they may be arranged in parallel and both apparatus 17 and 17′ are fed from the agitated tank 15 only. In certain embodiments, the first magnetic separation products coming from WHIMs 17 and 17′ are passed together to dewatering unit 24 and the dewatered product 26 is collected via belt 25 for optional further processing.

The process of the present invention will be illustrated by the following examples, which are not intended to limit the scope of the present invention.

### EXAMPLES

Unless otherwise stated, all parts and percentages are by weight. The properties reported in the detailed description and in the examples have been measured according to the methods reported in the following.

After each magnetic separation test, the drained magnetic (i.e., the second magnetic separation product) and non-magnetic fractions (i.e., the first magnetic separation product) were filtered and dried in an oven at 110° C. The chemical composition of each sample was investigated using on bead X-Ray Fluorescence (Brucker—S4 Explorer). LOI (loss on ignition) was determined by measuring the sample weight and after firing at 1050° C. for 1 hour. The brightness of each sample was investigated after grinding (d₅₀=200 μm) and firing at 1200° C. by using a spectrophotometer CM-2600d supplied by Konica Minolta.

A feldspar product is normally distinguished in terms of a “quality” grade, depending on its chemical composition. Grades include ‘Standard Quality’, ‘Medium Quality’, ‘Extra Quality’ and ‘Floated Quality’. Characteristic chemical compositions for each grade are summarized in Tables 1-4 below.

TABLE 1
Chemical composition - Standard Quality

| SiO₂ | Al₂O₃ | Fe₂O₃ | TiO₂ | CaO | MgO | Na₂O | K₂O | P₂O₅ |
|---|---|---|---|---|---|---|---|---|
| 71 ± | 17.82 ± | 0.18 ± | 0.33 ± | 0.65 ± | 0.1 ± | 9.75 ± | 0.3 ± | 0.20 ± |
| 1 | 0.5 | 0.02 | 0.02 | 0.05 | 0.05 | 0.25 | 0.05 | 0.05 |

TABLE 2
Chemical composition - Medium Quality

| SiO₂ | Al₂O₃ | Fe₂O₃ | TiO₂ | CaO | MgO | Na₂O | K₂O | P₂O₅ |
|---|---|---|---|---|---|---|---|---|
| 71.0 | 18.0 | 0.13 ± | 0.24 ± | 0.63 | 0.30 | 9.25 ± | 0.30 | 0.15 |
| | | 0.02 | 0.02 | | | 0.25 | | |

TABLE 3
Chemical composition - Extra Quality

| SiO₂ | Al₂O₃ | Fe₂O₃ | TiO₂ | CaO | MgO | Na₂O | K₂O | P₂O₅ |
|---|---|---|---|---|---|---|---|---|
| 70.2- | 18.2 | 0.05- | 0.08- | 0.55 | 0.30- | 9.25- | 0.30- | 0.10- |
| 71.1 | | 0.09 | 0.18 | | 0.33 | 10.00 | 0.41 | 0.12 |

TABLE 4
Chemical composition - Floated Quality

| SiO₂ | Al₂O₃ | Fe₂O₃ | TiO₂ | CaO | MgO | Na₂O | K₂O | P₂O₅ |
|---|---|---|---|---|---|---|---|---|
| 71.7 | 17.8 | 0.04 ± | 0.04 ± | 0.44 | 0.02 | 10.00 ± | 0.26 | 0.00 |
| | | 0.01 | 0.01 | | | 0.25 | | |

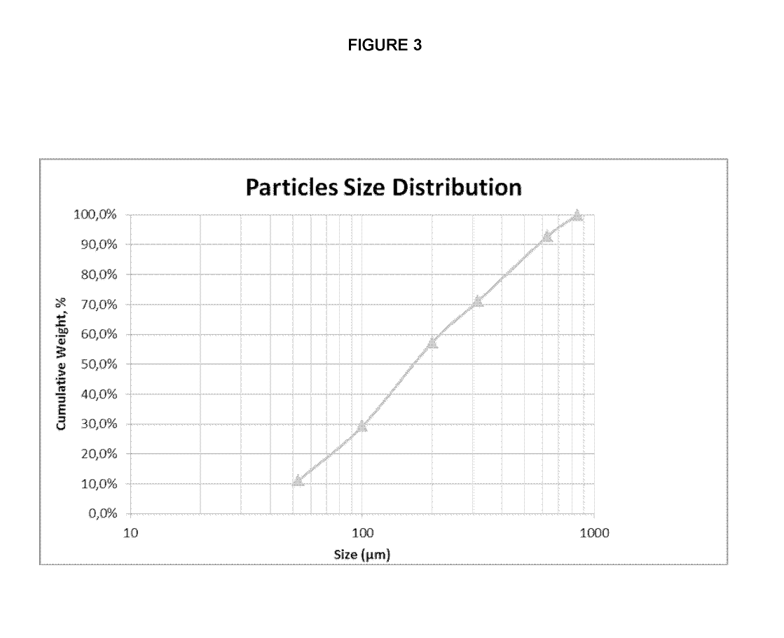

A crushed material (consisting essentially of particles less than 0.8 mm, i.e. 800 μm) obtained from an Turkish albititic deposit having the composition reported in Table 5 (dry form) and the particles size distribution given in FIG. 3, was used in these examples. Both iron and titanium contents are higher than the acceptable standards and therefore this sample was out of any specifications.

TABLE 5

| | Chemical composition - Crushed material −800 μm | | | | | | | | | | |
|---|---|---|---|---|---|---|---|---|---|---|---|
| | SiO₂ | Al₂O₃ | Fe₂O₃ | TiO₂ | CaO | MgO | Na₂O | K₂O | P₂O₅ | LOI | Total |
| +630 μm | 68.02 | 17.95 | 0.16 | 0.36 | 0.65 | 0.10 | 9.76 | 0.43 | 0.19 | 0.61 | 98.2 |
| 315- | 67.46 | 17.97 | 0.28 | 0.46 | 0.99 | 0.25 | 9.48 | 0.62 | 0.43 | 0.65 | 98.6 |
| 630 μm | | | | | | | | | | | |
| 200- | 66.08 | 18.22 | 0.36 | 0.47 | 1.33 | 0.37 | 9.37 | 0.73 | 0.67 | 0.69 | 98.3 |
| 315 μm | | | | | | | | | | | |
| 100- | 66.30 | 18.93 | 0.30 | 0.35 | 1.02 | 0.28 | 10.02 | 0.60 | 0.43 | 0.63 | 98.9 |
| 200 μm | | | | | | | | | | | |
| 53- | 65.60 | 19.05 | 0.28 | 0.45 | 0.94 | 0.23 | 10.14 | 0.51 | 0.36 | 0.54 | 98.1 |
| 100 μm | | | | | | | | | | | |
| −53 μm | 63.59 | 19.36 | 0.72 | 0.93 | 1.11 | 0.51 | 8.95 | 0.78 | 0.43 | 1.76 | 98.2 |
| Total | 66.21 | 18.63 | 0.34 | 0.48 | 1.02 | 0.29 | 9.70 | 0.61 | 0.43 | 0.75 | 98.5 |

### Examples 1-3

Three samples were prepared as follows:
coarse particles more than 315 μm are discarded by wet sieving;
slimes particles less than 53 μm are removed by wet sieving.

The average chemical composition of the 53-315 μm feed material is given by Table 6.

TABLE 6
Chemical composition - Examples 1-3 feed material 53-315 μm

| SiO₂ | Al₂O₃ | Fe₂O₃ | TiO₂ | CaO | MgO | Na₂O | K₂O | P₂O₅ | LOI | Total |
|---|---|---|---|---|---|---|---|---|---|---|
| 65.82 | 18.47 | 0.28 | 0.43 | 1.08 | 0.25 | 9.88 | 0.58 | 0.46 | 0.53 | 97.77 |

Then, for each example, an Eriez HI FILTER 25-100 wet high intensity magnetic separation (WHIMS) machine was fed with a 30 wt. % solids aqueous suspension at about 60 L/min, corresponding to a velocity of the aqueous suspension equal to 4.7 cm/s into the canister. The canister is equipped with the FX matrix (5.84×3.38 mm). For each sample, two steps of Magnetic Separation are carried out, i.e. the nonmagnetic product collected from the first step of magnetic separation is used as feed to the machine during the second step. The weight recoveries, the chemical compositions of both magnetic and nonmagnetic fractions and the losses in feldspar occurring during each step of magnetic separation are respectively reported in Table 8 and Table 9. In Example 1, no chemical reagent is added before the first stage of magnetic separation and the resulting non-magnetic product collected from this first magnetic separation stage is then conditioned at 68 wt. % solids aqueous suspension during 10 minutes in presence of 10.8 kg/t of magnet enhancer reagent Aero NSK-150 and 0.95 kg/t of selective organic reagent Aero NSK-200. During the conditioning, the pH of the aqueous suspension is adjusted to about 9.4 by adding sodium hydroxide.

In Example 2, the aqueous suspension of feldspar containing material is conditioned before each step of magnetic separation with both magnet enhancer reagent Aero NSK-150 (about 20 kg/ton before each magnetic separation step) and selective organic reagent Aero NSK-200 (about 1.3 kg/ton before each step of magnetic separation) at 68 wt. % solids during 10 minutes. No pH modifier is added to the pulp in the conditioning tank.

In Example 3, the procedure of Example 2 is repeated, save that selective organic reagent Aero NSK-300 is used instead of Aero NSK-200. The dosage of Aero NSK-300 is equivalent to the one of Aero NSK-200 added to the feldspar containing aqueous suspension before each conditioning stage in Example 2.

The operating parameters applied for Examples 1-3 are summarized in Table 7.

TABLE 7

| | Conditioning Stage No. 1 | | | | | Conditioning Stage No. 2 | | | | |
|---|---|---|---|---|---|---|---|---|---|---|
| | Magnet | Selective | | | | Magnet | Selective | | | |
| | Enhancer | Organic | % | | | Enhancer | Organic | % | | |
| | reagent | reagent | Solids | Duration | pH | reagent | reagent | Solids | Duration | pH |
| Example | X | X | X | X | X | NSK-150 | NSK-200 | 68 | 10 min | 9.4 |
| 1 | | | | | | (10.8 | (0.95 | | | |
| | | | | | | kg/t) | kg/t) | | | |
| Example | NSK-150 | NSK-200 | 68 | 10 min | 7.0 | NSK-150 | NSK-200 | 68 | 10 min | 9.0 |
| 2 | (21.82 | (1.44 | | | | (19.52 | (1.29 | | | |
| | kg/t) | kg/t) | | | | kg/t) | kg/t) | | | |
| Example | NSK-150 | NSK-300 | 68 | 10 min | 7.0 | NSK-150 | NSK-300 | 68 | 10 min | 9.0 |
| 3 | (20.36 | (1.34 | | | | (21.53 | (1.32 | | | |
| | kg/t) | kg/t) | | | | kg/t) | kg/t) | | | |

TABLE 8

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Example | Mag 1 | 4.9 | 3.73 | 3.20 | 4.15 | 65.7 | 38.1 | 2.1 |
| 1 | Non Mag 1 | 95.1 | 0.09 | 0.27 | 10.00 | 34.3 | 61.9 | 97.9 |
| | Feed | 100.0 | 0.28 | 0.41 | 9.71 | 100.0 | 100.0 | 100.0 |
| | (Calc.) | | | | | | | |
| Example | Mag 1 | 7.2 | 2.96 | 2.31 | 4.71 | 74.9 | 47.3 | 3.4 |
| 2 | Non Mag 1 | 92.8 | 0.08 | 0.20 | 10.29 | 25.1 | 52.7 | 96.6 |
| | Feed | 100.0 | 0.29 | 0.35 | 9.89 | 100.0 | 100.0 | 100.0 |
| | (Calc.) | | | | | | | |
| Example | Mag 1 | 6.5 | 3.22 | 1.95 | 4.30 | 71.5 | 45.0 | 2.8 |
| 3 | Non Mag 1 | 93.5 | 0.09 | 0.17 | 10.35 | 28.5 | 55.0 | 97.2 |
| | Feed | 100.0 | 0.29 | 0.30 | 9.96 | 100.0 | 100.0 | 100.0 |
| | (Calc.) | | | | | | | |

TABLE 9

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Example | Mag 2 | 9.6 | 0.48 | 1.84 | 7.70 | 53.2 | 64.1 | 7.2 |
| 1 | Non Mag 2 | 90.4 | 0.05 | 0.11 | 10.48 | 46.8 | 35.9 | 92.8 |
| | Feed | 100.0 | 0.10 | 0.28 | 10.21 | 100.0 | 100.0 | 100.0 |
| | (Calc.) | | | | | | | |
| Example | Mag 2 | 5.3 | 0.78 | 2.65 | 7.21 | 58.4 | 74.9 | 5.1 |
| 2 | Non Mag 2 | 94.7 | 0.04 | 0.07 | 10.48 | 41.6 | 25.1 | 94.9 |
| | Feed | 100.0 | 0.10 | 0.26 | 10.25 | 100.0 | 100.0 | 100.0 |
| | (Calc.) | | | | | | | |
| Example | Mag 2 | 5.8 | 1.04 | 2.25 | 7.39 | 58.6 | 73.0 | 4.2 |
| 3 | Non Mag 2 | 94.2 | 0.05 | 0.05 | 10.45 | 41.4 | 27.0 | 95.8 |
| | Feed | 100.0 | 0.10 | 0.18 | 10.27 | 100.0 | 100.0 | 100.0 |
| | (Calc.) | | | | | | | |

The addition of magnet enhancer reagent and selective organic reagent before each step of magnetic separation enhances the titanium removal from the feldspar containing aqueous suspension and the nonmagnetic concentrate obtained after two runs through the magnet is at the limit Extra Quality/Floated Quality (Example 2) whereas only Extra Quality grade is reached when magnet enhancer technology is used only before the second step of magnetic separation (Example 1). When the selective organic reagent Aero NSK-300 is used instead of Aero NSK-200, the nonmagnetic concentrate obtained after two steps of magnetic separation is equivalent to a floated grade (Example 3).

### Examples 4-5

Two additional samples are prepared by removing the slimes particles less than 53 μm by wet sieving while the coarse fraction is not discarded.

The average chemical composition of the 53-800 μm feed material is given by Table 10.

TABLE 10
Chemical composition - Examples 4-5 feed material 53-800 μm

| SiO₂ | Al₂O₃ | Fe₂O₃ | TiO₂ | CaO | MgO | Na₂O | K₂O | P₂O₅ | LOI | Total |
|---|---|---|---|---|---|---|---|---|---|---|
| 66.75 | 18.14 | 0.25 | 0.41 | 1.02 | 0.21 | 9.77 | 0.56 | 0.41 | 0.52 | 98.04 |

Then, for each sample, an Eriez HI FILTER 25-100 wet high intensity magnetic separation (WHIMS) machine was fed with a 30 wt. % solids aqueous suspension at about 60 L/min, corresponding to a velocity of the aqueous suspension equal to 4.7 cm/s into the canister. The canister is equipped with the BEX matrix (9.95×6.60 mm). As previously, two steps of Magnetic Separation are carried out, i.e. the nonmagnetic product collected from the first step of magnetic separation is used as feed to the machine during the second step. The weight recoveries, the chemical compositions of both magnetic and nonmagnetic fractions and the losses in feldspar occurring during each step of magnetic separation are respectively reported in Table 12 and Table 13.

In Example 4, the aqueous suspension of feldspar containing material is conditioned before each step of magnetic separation with both magnet enhancer reagent Aero NSK-150 (about 20 kg/ton before each magnetic separation step) and selective organic reagent Aero NSK-300 (about 1.3 kg/ton before each step of magnetic separation) at 68 wt. % solids during 10 minutes. No pH modifier is added to the pulp in the conditioning tank.

In Example 5, the procedure of Example 4 is repeated, save that the aqueous suspension of feldspar containing material is conditioned with magnet enhancer reagent and selective organic reagent at 30 wt. % solids during 5 minutes.

The operating parameters applied for Examples 4-5 are summarized in Table 11.

TABLE 11

| | Conditioning Stage No. 1 | | | | | Conditioning Stage No. 2 | | | | |
|---|---|---|---|---|---|---|---|---|---|---|
| | Magnet | Selective | | | | Magnet | Selective | | | |
| | Enhancer | Organic | % | | | Enhancer | Organic | % | | |
| | reagent | reagent | Solids | Duration | pH | reagent | reagent | Solids | Duration | pH |
| Example | NSK-150 | NSK-300 | 68 | 10 min | 7.0 | NSK-150 | NSK-300 | 68 | 10 min | 9.0 |
| 4 | (20.99 | (1.38 | | | | (19.61 | (1.30 | | | |
| | kg/t) | kg/t) | | | | kg/t) | kg/t) | | | |
| Example | NSK-150 | NSK-300 | 30 | 5 min | 7.0 | NSK-150 | NSK-300 | 30 | 5 min | 9.0 |
| 5 | (20.70 | (1.37 | | | | (21.55 | (1.42 | | | |
| | kg/t) | kg/t) | | | | kg/t) | kg/t) | | | |

TABLE 12

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Example | Mag 1 | 12.2 | 1.91 | 2.27 | 5.77 | 82.3 | 70.0 | 7.2 |
| 4 | Non Mag 1 | 87.8 | 0.06 | 0.14 | 10.34 | 17.7 | 30.0 | 92.8 |
| | Feed | 100.0 | 0.28 | 0.40 | 9.78 | 100.0 | 100.0 | 100.0 |
| | (Calc.) | | | | | | | |
| Example | Mag 1 | 12.1 | 1.80 | 2.24 | 6.29 | 75.5 | 63.5 | 7.8 |
| 5 | Non Mag 1 | 87.9 | 0.08 | 0.18 | 10.18 | 24.5 | 36.5 | 92.2 |
| | Feed | 100.0 | 0.29 | 0.43 | 9.71 | 100.0 | 100.0 | 100.0 |
| | (Calc.) | | | | | | | |

TABLE 13

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Example | Mag 2 | 14.8 | 0.27 | 0.77 | 9.47 | 59.3 | 79.7 | 13.6 |
| 4 | Non Mag 2 | 85.2 | 0.03 | 0.03 | 10.50 | 40.7 | 20.3 | 86.4 |
| | Feed | 100.0 | 0.07 | 0.14 | 10.35 | 100.0 | 100.0 | 100.0 |
| | (Calc.) | | | | | | | |
| Example | Mag 2 | 17.0 | 0.31 | 0.63 | 9.55 | 55.7 | 62.2 | 16.0 |
| 5 | Non Mag 2 | 83.0 | 0.05 | 0.08 | 10.31 | 44.3 | 37.8 | 84.0 |
| | Feed | 100.0 | 0.09 | 0.17 | 10.18 | 100.0 | 100.0 | 100.0 |
| | (Calc.) | | | | | | | |

The presence of coarse particles comprised between 315 and 800 μm doesn't affect the quality of the final nonmagnetic concentrate obtained after two steps of magnetic separation which is equivalent to a floated grade (Example 4). However, the selectivity of the process is impacted due to the loss of coarse feldspar grains which are trapped in the matrix with the magnetic particles and the global mass recovery is reduced.

Furthermore, when the solids content of the aqueous suspension and duration of conditioning stages are reduced, the quality of the final nonmagnetic product obtained after two steps of magnetic separation is affected and is at the limit Extra Quality/Floated Quality.

### Comparative Example 1

An additional sample is prepared by repeating the procedure applied in Examples 1-3:
coarse particles more than 315 μm are discarded by wet sieving;
slimes particles less than 53 μm are removed by wet sieving.

Then, an Eriez HI FILTER 25-100 wet high intensity magnetic separation (WHIMS) machine was fed with a 30 wt. % solids aqueous suspension at about 60 L/min, corresponding to a velocity of the aqueous suspension equal to 4.7 cm/s into the canister. The canister is equipped with the FX matrix (5.84×3.38 mm). Two steps of Magnetic Separation are carried out, i.e. the nonmagnetic product collected from the first step of magnetic separation is used as feed to the machine during the second step. The weight recoveries, the chemical compositions of both magnetic and nonmagnetic fractions and the losses in feldspar occurring during each step of magnetic separation are respectively reported in Table 14 and Table 15.

In Comparative Example 1, no chemical reagent is added to the feldspar containing aqueous suspension prior to any of the two magnetic separation stages.

TABLE 14

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Comparative | Mag 1 | 5.4 | 3.97 | 4.38 | 2.30 | 80.0 | 50.5 | 1.3 |
| Example 1 | Non Mag 1 | 94.6 | 0.06 | 0.25 | 10.26 | 20.0 | 49.5 | 9.7 |
| | Feed | 100.0 | 0.27 | 0.47 | 9.83 | 100.0 | 100.0 | 100.0 |
| | (Calc.) | | | | | | | |

TABLE 15

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Comparative | Mag 2 | 1.8 | 1.27 | 4.64 | 4.34 | 28.7 | 37.8 | 0.8 |
| Example 1 | Non Mag 2 | 98.2 | 0.06 | 0.14 | 10.40 | 71.3 | 62.2 | 99.2 |
| | Feed | 100.0 | 0.08 | 0.23 | 10.29 | 100.0 | 100.0 | 100.0 |
| | (Calc.) | | | | | | | |

The Comparative Example 1 confirms that the addition of effective magnet enhancer reagents enhances significantly the removal of titanium-bearing minerals from an aqueous suspension of feldspar containing material. When no reagents are added to the suspension prior to the magnetic separation, the final nonmagnetic concentrate obtained after two steps of magnetic separation is only an Extra Grade.

### Comparative Example 2

An additional sample is prepared by repeating the procedure applied in Examples 1-3:
coarse particles more than 315 μm are discarded by wet sieving;
slimes particles less than 53 μm are removed by wet sieving.

Then, an Eriez HI FILTER 25-100 wet high intensity magnetic separation (WHIMS) machine was fed with a 30 wt. % solids aqueous suspension at about 60 L/min, corresponding to a velocity of the aqueous suspension equal to 4.7 cm/s into the canister. The canister is equipped with the FX matrix (5.84×3.38 mm). No chemical reagent is added to the feldspar containing aqueous suspension prior to the magnetic separation process.

Contrary to the Comparative Example 1, only one magnetic separation step is performed in Comparative Example 2 and the nonmagnetic product collected from the first step of magnetic separation is floated after acidic conditioning at 65 wt. % solids during 5 minutes in the presence of anionic flotation collector (i.e. petroleum sulfonate, 1.59 kg/t). The weight recoveries, the chemical compositions and the losses in feldspar occurring during both magnetic separation step and flotation step are respectively reported in Table 16 and Table 17.

TABLE 16

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Comparative | Mag 1 | 5.4 | 3.97 | 4.38 | 2.30 | 80.0 | 50.5 | 1.3 |
| Example 2 | Non Mag 1 | 94.6 | 0.06 | 0.25 | 10.26 | 20.0 | 49.5 | 9.7 |
| | Feed | 100.0 | 0.27 | 0.47 | 9.83 | 100.0 | 100.0 | 100.0 |
| | (Calc.) | | | | | | | |

TABLE 17

| | | Mass | | | | | | |
|---|---|---|---|---|---|---|---|---|
| | | Balance | Oxide Content, % | | | Oxide recovery, % | | |
| | | Wt. % | Fe₂O₃ | TiO₂ | Na₂O | Fe₂O₃ | TiO₂ | Na₂O |
| Comparative | Flot. Wastes | 10.1 | 0.33 | 1.36 | 7.34 | 46.5 | 67.7 | 7.3 |
| Example 2 | Flot. | 89.9 | 0.04 | 0.07 | 10.56 | 53.5 | 32.3 | 92.7 |
| | Concentrate | | | | | | | |
| | Feed (Calc.) | 100.0 | 0.07 | 0.21 | 10.23 | 100.0 | 100.0 | 100.0 |

Compare to a process composed of conventional high gradient magnetic separation followed by conventional froth flotation, the present invention gives at least equivalent results (Examples 2 and 5) or even better (Examples 3 and 4).

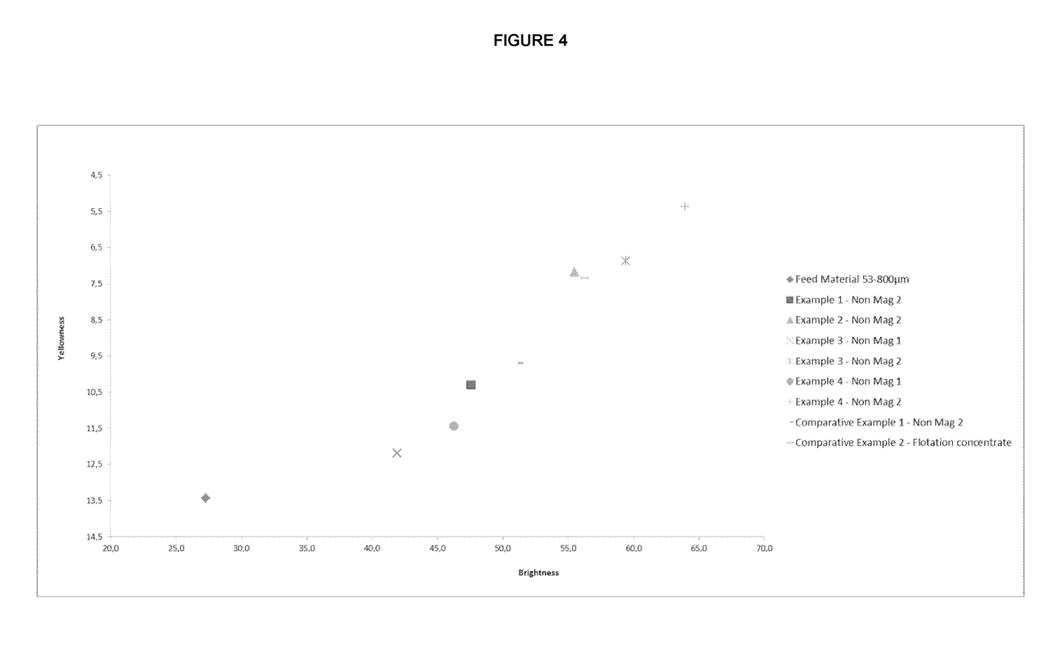

The brightness measurements performed on each sample introduced by the above examples are given by the FIG. 4.

1. A process for beneficiating a feldspar and/or feldspathoid containing feed material which comprises magnetic impurities, non-magnetic impurities and non-magnetic minerals to be beneficiated; said process comprising:
(a) providing, obtaining or preparing a feldspar and/or feldspathoid containing feed material which comprises magnetic impurities, non-magnetic impurities and non-magnetic minerals to be beneficiated;
(b) forming an aqueous composition comprising the feldspar and/or feldspathoid containing feed material and a magnetic enhancer reagent, wherein the magnetic enhancer reagent comprises one or more magnetic oxide particulate and one or more surface active agent;
(c) subjecting said aqueous composition to wet magnetic separation to produce a non-magnetic separation product having a reduced level of magnetic and non-magnetic impurities, and a magnetic separation product comprising the magnetic and non-magnetic impurities removed from the aqueous composition.

2. A process according to claim 1, wherein prior to wet magnetic separation, the process comprises sizing the feldspar and/or feldspathoid containing feed material into a fine fraction and a coarse fraction, wherein the coarse fraction comprises particles greater than about 1 mm (1000 μm) in size.

3. A process according to claim 2, wherein the fine fraction comprises particles up to about 850 μm in size.

4. A process according to claim 3, wherein the fine fraction comprises at least 10 wt. % of particles at least 200 μm in size, based on the total weight of the fine fraction.

5. A process according to claim 1, wherein the magnetic oxide particulate of the magnet enhancer reagent has a particle size of no greater than about 100 μm.

6. A process according to claim 1, wherein the aqueous composition further comprises a secondary selective organic reagent which enhances the separation of magnetic-impurities and/or non-magnetic impurities from the aqueous composition, and wherein the secondary selective organic reagent is other than the surface active agent of the magnetic enhancer reagent.

7. A process according to claim to claim 1, wherein the magnetic oxide is represented by the formula MO, wherein M is a divalent metal selected from one or more of Fe, Ni, Co, Mn and Mg, wherein the surface active agent is a surfactant or blend of surfactants, wherein the or each surfactant has an HLB of 10 or less.

8. A process according to claim 1, wherein the surface active agent is selected from a surface active reagent of the formula R—(CONH—O—X)n, wherein n is from 1 to 3; X is individually selected from the group consisting of H, M and MR′4; M is a metal ion (e.g., lithium, sodium, potassium, magnesium, or calcium, preferably sodium or potassium); R comprises from about 1 to about 50 carbon atoms; and each R′ is individually selected from the group consisting of H, C1-C10 alkyl, C6-C10 aryl and C7-C10 aralkyl and combinations thereof.

9. A process according to claim 1, wherein the magnetic oxide particulate comprises magnetite; and wherein the magnetic enhancer reagent is AERO NSK-150.

10. A process according to claim 6, wherein secondary selective organic reagent is a surfactant or blend of surfactants, optionally wherein the surfactant or at least one of the surfactants is a chelating surfactant.

11. A process according to claim 10, wherein the chelating surfactant is a hydroxamate, for example, an alkyl hydroxamate.

12. A process according to claim 1, wherein said aqueous composition has a solids content of from about 5 wt. % to about 70 wt %.

13. A process according to claim 1, wherein the aqueous composition is conditioned, for example, under high shear conditions.

14. A process according to claim 1, wherein the pH of the aqueous composition is or is adjusted to about 2.0 to about 11.0.

15. A process according to claim 1, wherein the wet magnetic separation is high gradient magnetic separation in which the background magnetic field applied is at least about 0.5 Tesla.

16. A process according to claim 1, wherein step (c) is repeated one or more times.

17. A process according to claim 1, wherein prior to step (b), the feldspar and/or feldspathoid containing feed material is subjected to magnetic separation to remove magnetic impurities and to form a first non-magnetic separation product having a reduced level of magnetic impurities, and wherein the aqueous composition of step (b) is formed from the first non-magnetic separation product.

18. A process according to claim 1, wherein the feldspar and/or feldspathoid containing feed material comprises quartz minerals, and wherein, prior to wet magnetic separation (i) a non-magnetic separation product is subjected to a flotation process to remove quartz minerals, or (ii) quartz minerals are separated from the feed material and/or the fine fraction formed therefrom.

19. A process according to claim 1, wherein the process does not include a flotation process to remove non-magnetic impurities.

20. A process according to claim 1, wherein the process does not include a flotation process.

21. A process according to claim 2, wherein the feldspar containing feed material is screened to obtain the fine fraction and course fraction using a screen which possesses a hole size of 1 mm

22. A process according to claim 2, wherein the first magnetic separation product is blended with said course fraction.

23. A process according to claim 3, wherein the fine fraction comprises particles up to about 630 μm in size.

24. A process according to claim 3, wherein the fine fraction comprises particles up to about 315 μm in size.

25. A process according to claim 15, wherein the background magnetic field applied is no greater than about 2.0 Tesla.
